(19) United States
(12) Patent Application Publication
(10) Pub. No.: US 2004/0002897 A1
(43) Pub. Date: Jan. 1, 2004

(54) In-store (on premises) targeted marketing services for wireless customers

(76) Inventor: Claire Svetlana Vishik, Austin, TX (US)

Correspondence Address: LACASSE & ASSOCIATES, LLC, 1725 DUKE STREET, SUITE 650, ALEXANDRIA, VA, 22314, US

(21) Appl. No.: 10/248,507

(22) Filed: Jan. 24, 2003

Related U.S. Application Data
(63) Continuation-in-part of application No. 10/180,521, filed on Jun. 27, 2002.

(51) Int. Cl. G06F 17/60

(52) U.S. Cl. 705/14

(57) ABSTRACT

Upon arrival in a store, the identity and profile of wireless customers are determined. In one embodiment, the wireless device associated with users relays to the promotion system specific identification numbers (IDs) obtained from a wireless device corresponding to the customers. Then, the promotion system uses the IDs to retrieve a stored profile of the users in question and matches a plurality of promotions to their interests and habits. These promotions are then presented to the users either during shopping or at checkout.

### CROSS REFERENCE TO RELATED APPLICATIONS

The present application is a continuation-in-part of application Ser. No. 10/180,521 entitled “An Information Filling Station Facilitating Wireless Transfer of Data Content to a Portable Device or Other Pre-defined Locations”, filed Jun. 27, 2002, currently pending.

### BACKGROUND OF INVENTION

1. Field of Invention

The present invention relates generally to the field of wireless communications. More specifically, the present invention is related to a method of wireless in-store marketing.

2. Discussion of Prior Art

Data content providers presently push a myriad of data content (such as e-mail, data files, multimedia files, etc.) to various portable devices (such as personal computers, laptops, cellular phones, a personal digital assistant (PDA), etc.). Using portable wireless devices to advertise promotions is known. Typical systems use a location-based service, i.e., a global positioning system (GPS), to determine where users are located and, based on their location, provide advertisements or information to a registered portable device.

One popular method of implementing a wireless connection is based upon the IEEE 802.11 standard. 802.11 refers to a family of specifications developed by the Institute of Electrical and Electronics Engineers (IEEE) for wireless local area network (LAN) technology. 802.11 specifies an over-the-air interface between a wireless client and a base station or between two wireless clients. There are several specifications in the 802.11 family, some of which are described below:

802.11—applies to wireless LANs providing 1 or 2 Mbps transmission in the 2.4 band using either frequency hopping spread spectrum (FHSS) or direct sequence spread spectrum (DSSS).

802.11a—an extension to 802.11 that applies to wireless local area networks (LANs) and provides up to 54 Mbps in the 5 GHz band. 802.11a uses an orthogonal frequency division multiplexing encoding scheme rather than FHSS or DSSS.

802.11b—also referred to as 802.11 High rate or Wi-Fi (for wireless fidelity), formed as a ratification to the original 802.11 standard, allowing wireless functionality comparable to the Ethernet. This is an extension to 802.11 that applies to wireless LANs and provides 11 Mbps transmission (with fallback to 5.5, 2, and 1 Mbps) in the 2.4 GHz band. Transmission in the 802.11b standard is accomplished via DSSS.

802.11g—applies to wireless LANs and provides 20+ Mbps in the 2.4 GHz band.

The most popular of the above standards is the 802.11b. One problem associated with this standard is that the signal strength fades away as a function of distance and, as a result, the data rate falls back to 5.5, 2, or 1 Mbps, depending on the distance from the Wi-Fi router/hub and the strength of the signal.

The use of joint marketing agreements has become common between companies. For example, owners of an airline's frequent flyer accounts can register their credit cards to receive discounts with select merchants, or owners of loyalty cards at grocery stores can register to receive airline miles based on the frequency and amount they spend while shopping. Current programs, however, are not adapted to fit both the customers' and the vendors' needs.

FIG. 1 illustrates a prior art system wherein the customer enters the store 100 and is identified by the reader 102. Once identified, the information is sent either to access the customer's profile 104 or the store database 110. If the system accesses the customer's profile, promotions are selected according to the customer's personal preferences 106. The promotions are then provided to the customer 108. If the system accesses the store database, the promotions that are being offered at the store are selected 112 and provided to the customer 114. Customers at a particular location receive generic discounts for the store or location they are in (according to the promotion that the store is offering), or they receive promotions that are limited to their profile as stored in the store's database. For instance, a user may enter a popular grocery store and receive notification of a promotion for cigarettes when the user has never smoked or purchased cigarettes. This offer will be of no interest to the customer and will not benefit either party. Another example of generic systems is a scenario wherein a customer registers a credit card for a car rental program. A discount is automatically applied and refunded by the credit card company when the customer rents a car through a participating company.

In another example, customers enter a particular electronics store and use their credit card, their credit card entitling them to a discount for any purchase over a set amount. A refund is provided by the credit card company.

Referring to the first example if customers smoke and receive a coupon for a particular brand of cigarettes that they enjoy, they will be more inclined to take the offered promotion. This promotion, however, may not necessarily benefit specific vendors. As mentioned, typical systems detect the location of a customer in a store and offer the customer promotions by consulting a profile or similar registered information. These systems do not consider the needs of a specific store or vendor, and therefore the vendor may not receive maximum benefit from the customer's purchase.

There is concern with regard to the possibility of sharing private customer information such as the users' address or credit card number when users register to receive promotions and benefits. Because in typical systems the users develop a profile containing personal information, the users are subjected to a possibility of a lack of privacy from other marketing programs (for example, affiliated stores where users did not register) and from any persons associated with the merchant's in-store computer. The users may opt to receive these advertisements, but it can be cumbersome and distracting to peruse information that is of no interest to the customer.

The following references provide a general description related to the process of informing customers of marketing promotions in a retail environment.

The patent to Suzuki (U.S. Pat. No. 6,129,274), assigned to Fujitsu Limited, provides for a system and method that updates customers' shopping transaction history through the use of an electronic personal digital assistant. Described is a customer identification (ID) card for use in a target advertisement in a retail environment.

The patent to Fano (U.S. Pat. No. 6,317,718 B1), assigned to Accenture Properties (2) B.V., provides for a method and article for location-based filtering for a shopper. Discussed is a location-based commercial offering system wherein users are provided with a plurality of offers depending upon their current location. In one embodiment, a GPS-enabled Personal Digital Assistant (PDA) associated with users displays customized offers received from the system to them.

The patent to Pentel (U.S. Pat. No. 6,435,406 B1) provides for a remote ordering device. Discussed is a method for ordering retail items over a wireless communication device. In one embodiment, buying orders, along with customer identification information, are transmitted to an order station. However, there is no mention of automatically providing promotions to users of the wireless device.

The published U.S. patent application to Tsukamoto (2001/0013120A1), assigned to NEC Corporation provides for a digital content rental system. Disclosed is a process that consists of customers visiting the store with a portable storage unit, such as a magnetic disk. The users may choose from a plurality of digital content and download desired content onto their storage medium.

The published U.S. patent application to Ramachandran et al. (2001/0044747A1), assigned to Diebold, Incorporated, provides for a system and method for dispensing digital information from an automated transaction machine. Disclosed is a service that offers digital content information to users through an automated transaction machine.

The patent application publication to Ogasawara (2002/0016740 A1) provides for a system and method that recognizes customers using wireless identification in a retail environment. In one embodiment, customers hold an identification card that is detected by an interrogation unit upon the entry of the customers in a store. The interrogation unit extracts from the card an identification number, which is matched against a customer information entry in a database in order to provide targeted incentives to the customers. There is no mention of matching the store's database to those interests of the customers.

The patent application publication to Anandan et al. (2002/0062251 A1) discusses a method for tracking the location of users in a retail environment in order to transmit targeted information to said users. In one embodiment, the location of the users is monitored by reading wireless identification information from the RF tag associated with the users. Then, a plurality of messages, including promotions, are transmitted to the users' wireless device.

The patent application publication to Katz (2002/0077901 A1), assigned to Catalina Marketing International, Inc., describes a method and system for matching a plurality of merchant promotions with a specific user profile. In one embodiment, the system detects users' identities upon detecting their presence in a location and delivers a plurality of promotions corresponding to the profile of said users. However, there is no specific mention of using a wireless device or of the benefit to the store location.

The patent application publication to Herwig (2002/0082925 A1) provides for a method for shopping using a handheld computing device as a shopping aid. A smart card maintains retail applications on a number of wireless devices.

The patent application publication to Allen (2002/0115449 A1) provides for a method for providing targeted information to users recognized by the system through a portable device. In one embodiment, users swipe an identification card through a reader and are recognized by the system by reading an identification embedded in portable card. A control center is then interrogated to retrieve targeted information associated with the identification in order to present the users with desired information. There is no mention, however, of targeting the needs of a particular store or location.

Whatever the precise merits, features, and advantages of the above-cited references, none of them achieves or fulfills the purposes of the present invention.

### SUMMARY OF INVENTION

The present invention represents a targeted, in-store marketing system that provides customers with in-store promotions via a wireless device, such as a cellular phone, personal digital assistant, or two-way pager. The users of the present invention develop an identification profile containing categories of interest, and in-store promotions are generated based on matching these categories of interest with available in-store promotions. The profile of interest for wireless users is determined and retrieved upon their arrival in the store. In one embodiment, the wireless device associated with users relays a specific ID to the promotion system. Then, the promotion system uses the ID to retrieve a stored profile of selected categories of interest for the users in question and matches a plurality of promotions that are being offered in the store to their interests and habits. These promotions are then presented to the users either during shopping or at checkout.

Vendors may benefit from the present method, rather than just customers. For example, if customers who smoke walked into a store that had overstocked the customers' preferred brand of cigarettes and receive a promotion for that preferred brand, both the customers and vendor will benefit from the exchange.

The current system maintains the anonymity of the customers, if so desired, by assigning an ID to each customer's profile (record) in the central system. Therefore, the customer-specific information does not have to be divulged or used during any type of transaction or information retrieval. Also, customers are able to choose categories that are of interest to avoid receiving promotions or discounts that do not appeal to them. Customers register a wireless device(s) and when the customers' ID is detected upon their arrival in a store, an in-store server retrieves the categories of interest of both the customers and the vendor to find a match and sends any of the matching promotions to the customers. The customers can choose to actively receive notifications of the promotions being offered, or they may passively receive the promotional offers at checkout. Further security can be provided by allowing customers to register a specific credit card with a required personal identification number (P.I.N.) or password, both of which must be used to obtain a promotion. Additionally, the device itself can be secured using biometrics means such as fingerprint recognition or voice recognition.

### BRIEF DESCRIPTION OF DRAWINGS

FIG. 1 illustrates prior art methods of providing promotions.

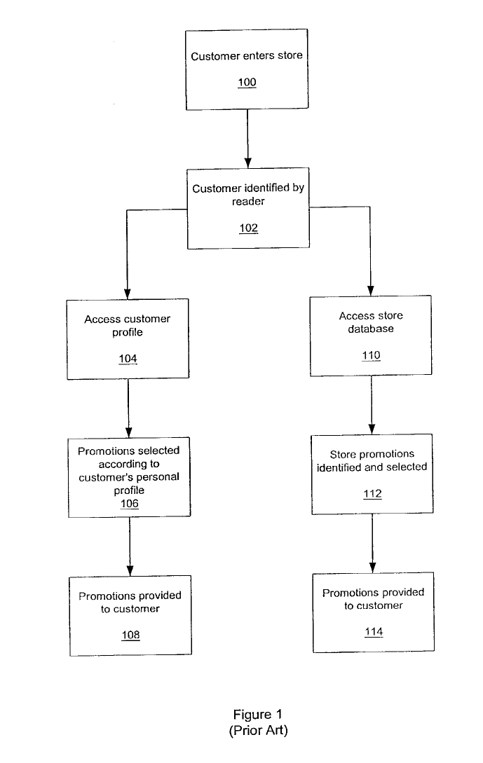

FIG. 2 illustrates a system diagram of the matching process.

FIG. 3 illustrates an active in-store method for delivering a promotion to customers.

FIG. 4 illustrates a passive in-store method for delivering a promotion to customers.

### DESCRIPTION OF THE PREFERRED EMBODIMENTS

While this invention is illustrated and described in a preferred embodiment, the device may be produced in many different configurations and forms. There is depicted in the drawings, and will herein be described in detail, a preferred embodiment of the invention, with the understanding that the present disclosure is to be considered an exemplification of the principles of the invention and the associated functional specifications for its construction and is not intended to limit the invention to the embodiment illustrated. Those skilled in the art will envision many other possible variations within the scope of the present invention. The terms customers and users may be used interchangeably through the specification.

An on-premises marketing service is targeted more to customer needs and vendor needs and, thus, is better for both customers and vendors, making joint marketing agreements more beneficial. Service is geared toward maximizing benefits for both customers and vendors, and also for affiliated providers of products and services. Instead of being confronted with generic promotions visible to everyone, customers receive special benefits targeted to their lifestyle or needs as well as promotions that are beneficial to the vendor's business.

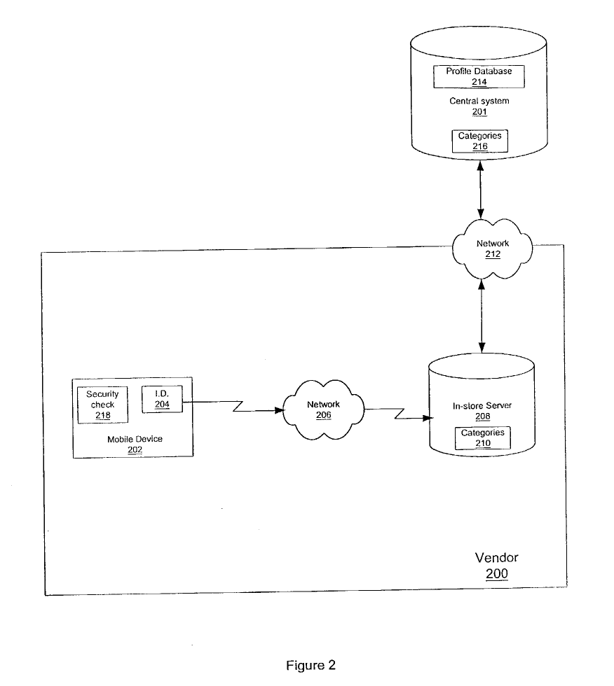

The present invention system is based on matching categories of promotions between the ones preferred by the customers (stored in the central or profile database) and those available in-store (local database or in-store server). FIG. 2 illustrates a system diagram of the present invention. The system is activated when customers enter premises 200 with a registered mobile device 202. Vendor 200 is preferably a store, vendor, or retail location, but is not limited thereto. Registered mobile device 202 emits a signal containing its identification number that is detected by network 206, and ID 204 is sent to in-store server 208. Preferably, the in-store server holds a number of promotions available at that location. More preferably, the in-store server holds the promotions available not only at the location of the ID holders (customers), but also of those stores, vendors, or retail locations that are associated with vendor 200. The promotions of the in-store server are divided and stored into categories 210 to allow for targeted matching. In-store server 208 contacts profile database 214 in central system 207 via network 212 to obtain profile information of detected ID 204. Network 212 preferably utilizes the Internet to contact database 214. The profile information available to the in-store server contains the categories of interest chosen by the ID holders (customers). In-store server 208 obtains the preferred categories 216 associated with the profile of that ID 204. In-store server 208 then matches the categorical preferences of ID 204 to the promotions of similar categories 210 located in in-store server 208. Various matching algorithms, from precise matching to complex rule-based matching approaches, can be employed to match categories of promotions in the profile and in-store system. For example, if a direct match is not available, the matching engine can produce partial matches based on underlying ontologies in the central and local promotions systems or prior successful promotions associated with the specific user ID.

Identification number (ID) 204 is assigned to a customer record in the targeted promotions system. The customers then register a mobile device with the system in order for the system to associate the assigned ID with the wireless device and, therefore, identify the device upon entry in a location. The profile can include information about multiple devices. The ID is kept even if the customers change the registered device. The customers' profile record includes information relevant to carrying out the promotion although the customers' identities might not be known to the store—only the fact that they are participating in targeted promotions. The information available to the store on premises is a subset of what is stored in the central system 201 (e.g. categories of interest are retrieved from the central profile, but personal information is not). The system authenticates the customers based on the wireless device ID and lists the promotions. For example, when customers enter the store with a registered device, the ID is detected by the system and promotions are provided to match both the customers' preferences and the vendor's offers. Because the matching is category-based and not based on personal information, customers' privacy is protected. In other words, the matching system does not know who the customers are; it only knows that the ID code is present in the store and that the customers have interests in categories ABC that correspond to in-store or co-marketing promotions A′B′C′.

When customers register with the targeted program, the customers preferably choose categories that are related to their profile. However, categories such as those associated with appropriate demographics or historical preferences (e.g., travel habits), could be assigned by default. The categories from which the customers choose can be particular stores, hobbies (such as travel and art), interests (such as music and computers), etc.

Additionally, as mentioned above, the system uses a matching process to provide the customers with targeted promotions. The matching process can be carried out using a variety of methodologies (including agents, search engines, automatic categorization, algorithms, etc.) to establish related categories of promotions directly available in-store or in directly related categories if promotions are not available at that specific location. That is, matches to company affiliates, vendors associated with customers' locations, and other facilities that match the ID profile may also be provided to the customers. For example, if customers choose frequent flyer miles programs as a top priority ranking but those programs are not associated with a certain store, the system may offer the customers points towards hotel stays if hotels are considered a closely related category in the ontology that is embedded in the promotions system.

Vendors can adopt the randomized promotions approach to maximize their benefits or adapt them to move merchandise or sell services that are in excess supply for an area. For example, instead of making generic companion certificates available, an airline may provide certificates for less busy itineraries but those adapted to customers' frequent destination or their departure airport. A store might adapt promotions to the beginning of the school year at a certain location or target specific stores where sales are slower than usual.

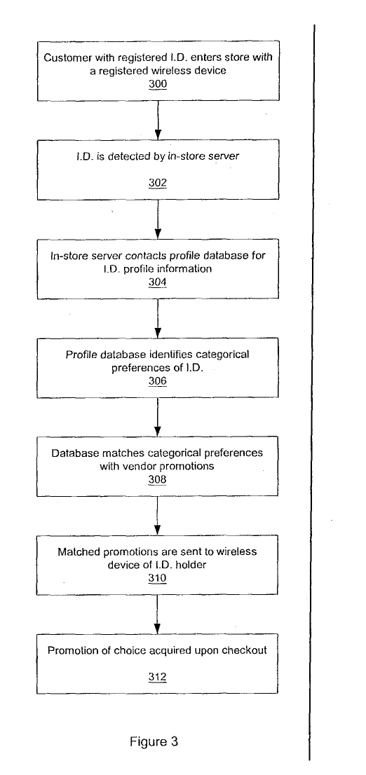

When customers register with the system and are assigned an ID, the customers are given the choices of two modes: active and passive. In active mode, the customers will be provided with promotions as soon as they are available on the registered wireless device. That is, the customers will see on-screen alerts for special deals or receive a call where the list of special deals will be available as a speech application. FIG. 3 illustrates the method of obtaining promotions in active mode. Registered customers enter a store location with a registered portable wireless device 300. The in-store server detects IDs 302 assigned to the customers. The server then contacts the profile database for information on identified IDs. 304. The categorical preferences of the IDs are identified 306 and matched with the categorical promotions of vendor 308. The matched promotions are then sent to registered wireless device(s) of the ID holders (customers) 310. Upon checkout, the customers may select a preferred promotion 312 to be applied during the completion of the transaction.

In one example, customers who registered for a joint marketing program walk into an electronics store. Their presence in the store is detected. The customers are registered for active co-marketing service. They are notified that there are special promotions for their account. The customers listen to the choices and select one of the choices that appeals to them (e.g., a free night's stay at a particular hotel upon spending a set amount, such as $200), and a certificate is printed for them upon checkout at the cashier.

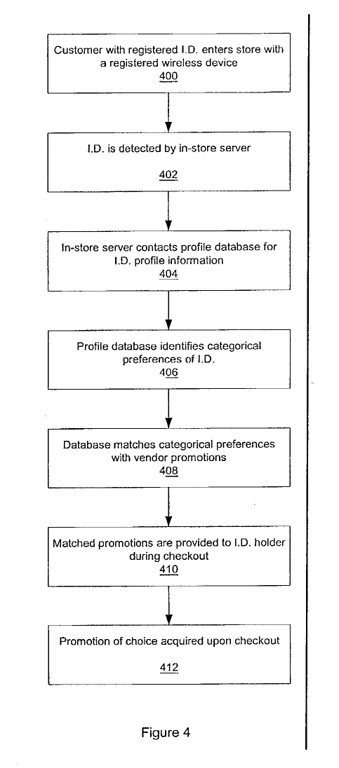

Should the customers choose to receive promotional notices passively, however, promotions will not be pushed to them until a transaction at checkout begins. That is, in passive mode, the customers do not receive notifications via the registered wireless device but are rather entitled to store- and customer-specific discounts during checkout. FIG. 4 illustrates the method of obtaining promotions in passive mode. Registered customers enter a store location with a registered portable wireless device 400. The in-store server detects IDs 402 assigned to the customers. The server then contacts the profile database for information on IDs 404. The categorical preferences of the IDs are identified 406 and matched with the promotions of vendor 408. The matched promotions are then sent to the store employee (for example, displayed at the register) so that they can be presented to the ID holders (customers) during checkout process 410. The customer may select a preferred promotion 412 to be applied during the completion of the transaction.

As previously mentioned, vendors 308 and 408 in this case may be the location at which the customers are located or another store or vendor associated therewith. The deals may not be storewide and can be personalized to benefit both the store and customers. For example, because the flight from Austin to Chicago is a frequent itinerary for customers, the customers can be notified that they will receive a free companion ticket to Chicago from Austin if they purchase product A. It is especially beneficial if, at the time of purchase, the flight from Austin to Chicago is not overly active for the airline and the store location they are in has to move the inventory of product A to make room for its successor.

Because the sharing of a customer's personal information may be of concern, the information about customers at a store or location can be limited to only the ID number, with no private information divulged in excess of what is already being done in joint marketing programs. Again, because the matching is category-based and not based upon personal information, customers' privacy is protected—the matching system of the in-store server does not know who the customers are; it only knows that the owners of the ID codes are present in the store and have interests in categories ABC that correspond to in-store or co-marketing promotions A′B′C′.

Additionally, the ID number can be encrypted for further security. Customers can choose to limit the identification information to the selected store or location, and their personal information will not be available to any associated merchants or any person associated with the store's in-store computer. Security issues are important for situations where the wireless device can be stolen or misplaced. By providing wireless devices with further security measures to ensure that the holder of the mobile device is the true and authenticated customer, a verification process chosen by the customers can be created within the system. The verification process can be offered before, during, or both before and during checkout. For example, if registered customers choose to actively receive promotions, their mobile device may request additional information such as registering a credit card, a personal identification number (P.I.N.) or password, biometrics, fingerprint recognition, or voice recognition as they walk into the store. If chosen, the customers can be asked again to re-verify themselves during checkout. Similarly, if customers choose to receive promotions passively, additional verification information may be requested during the customers' transaction to obtain the promotion. Whether the customers choose to exercise an extra security measure before, during, or both before and during a transaction, they will feel more secure in the use of their assigned IDs and anonymity.

The above invention and its described functional elements are implemented in various computing environments. For example, the present invention may be implemented on a conventional IBM PC or equivalent, multi-nodal system (e.g., LAN) or networking system (e.g., Internet, WWW, or wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of database and communications programming.

Additionally, the present invention provides for an article of manufacture comprising computer readable programming code contained within, implementing one or more modules for obtaining in-store (on premises) targeted marketing services for wireless customers. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage device.

Conclusion

A system and method have been shown in the above embodiments for the effective implementation of an in-store (on premises) targeted marketing service for wireless customers. While various preferred embodiments have been shown and described, it will be understood that there is no intent to limit the invention by such disclosure but, rather, it is intended to cover all modifications and alternate constructions falling within the spirit and scope of the invention, as defined in the appended claims. For example, the present invention should not be limited by software/program, computing environment, specific computing hardware, wireless technologies, mobile devices, or matching algorithms. The mobile device can either be carried in or integrated with any mobile device (e.g. a cellular phone or PDA), and the wireless communication between the mobile device and the server can be based upon the IEEE 802.11b protocol. Additionally, the system carries out promotions in real time based upon physical locations. Also, it does not require use of a location-based service (i.e., GPS) to function, although a GPS system may be included.

1. A system providing on-premises targeted promotions to customers, said system comprising:
a local server, said server receiving an identification of a proximate customer mobile device via a network;
said local server communicating with a profile database and receiving identifying categorical preference information associated with said identification number;
said local server matching said categorical profile preference information with local categorical promotional information to produce targeted matched promotions, and
said server electronically providing said matched promotions to said customers.

2. A system providing on-premises targeted promotions to customers as per claim 1, wherein said local categorical promotional information comprises promotions available at said premises.

3. A system providing on premises targeted promotions to customers, as per claim 1, wherein said local categorical promotional information comprises promotions available from vendors affiliated with said premises.

4. A system providing on-premises targeted promotions to customers, as per claim 1, wherein said network is a wireless communication network.

5. A system providing on-premises targeted promotions to customers, as per claim 1, wherein said profile database is located remote from said local server and said local server communicates with said remote profile database over the Internet.

6. A system providing on premises targeted promotions to customers, as per claim 1, wherein said local server matching provides promotions benefiting both customers and vendors of said local server.

7. A system providing on-premises targeted promotions to customers, as per claim 1, wherein said server electronically provides said matched promotions to customer mobile devices via said network.

8. A system providing on-premises targeted promotions to customers, as per claim 7, wherein said mobile device comprises a cellular telephone, personal digital assistant, or two-way pager.

9. A system providing on-premises targeted promotions to customers, as per claim 1, wherein said server electronically provides said matched promotions to customers during checkout transaction.

10. A system providing on-premises targeted promotions to customers, as per claim 1, wherein said customers choose a promotion from said matched promotions.

11. A system providing on-premises targeted promotions to customers, as per claim 1, wherein said chosen promotion is obtained during a checkout transaction.

12. A system providing on-premises targeted promotions to customers, as per claim 1, wherein said identification number is encrypted.

13. A system providing on-premises targeted promotions to customers, as per claim 1, wherein said mobile device requests said customer authentication information.

14. A system providing on-premises targeted promotions to customers, as per claim 13, wherein said authentication information is requested at the register during a checkout transaction.

15. A system providing on-premises targeted promotions to customers, as per claim 13, wherein said authentication information is requested before said matched promotions are provided to said customers.

16. A system providing on-premises targeted promotions to customers, as per claim 14 or claim 15, wherein said authentication information comprises one or more of the following: biometrics, a registered credit card, personal identification number, password, fingerprint authentication, or voice authentication.

17. A method providing on-premises targeted promotions to customers possessing an electronic mobile device, said method comprising:
wirelessly receiving an identification number of said customers' electronic mobile device;
a computer-based step of obtaining categorical profile preference information of said customers based on said identification number from a database;
a computer-based step of obtaining categorical promotional information available to said premises;
a computer-based step of matching said categorical profile preference information with said categorical promotional information to obtain relevant targeted promotions; and
electronically providing said relevant targeted promotions to said customers or store employee at checkout.

18. A method providing on-premises targeted promotions to customers, as per claim 17, wherein said method of electronically providing said targeted promotions comprises one, or a combination of: actively displaying said targeted matched promotions to said customers' mobile device, passively sending said targeted matched promotions to a register during a checkout transaction, or passively sending said targeted matched promotions to said customers' mobile device.

19. A method providing on-premises targeted promotions to customers, as per claim 17, wherein said mobile device comprises a cellular telephone, personal digital assistant, or two-way pager.

20. A method providing on-premises targeted promotions to customers, as per claim 17, further comprising choosing from said targeted promotions during a checkout transaction.

21. A method providing on-premises targeted promotions to customers, as per claim 17, requesting customer authentication information.

22. A method providing on-premises targeted promotions to customers, as per claim 21, wherein said authentication information is requested at the register during a checkout transaction.

23. A method providing on-premises targeted promotions to customers, as per claim 21, wherein said authentication information is requested before said matched promotions are provided to said customers.

24. A method providing on-premises targeted promotions to customers, as per claim 22 or claim 23, wherein said authentication information comprises one or more of the following: biometrics, a registered credit card, personal identification number, password, fingerprint authentication, or voice authentication.

25. A method implemented in a portable device to provide customers with promotions that are targeted to the preferences of said customers, based upon a wireless interaction between said portable device and a server, said server located proximate to said customers, said method comprising the steps of:
wirelessly relaying an identification number to said server;
receiving a match of categorical profile preference information associated with said identification number from a database, and categorical promotional information of said proximate location.
